(19) United States
(12) Patent Application Publication
(10) Pub. No.: US 2013/0137618 A1
(43) Pub. Date: May 30, 2013

(54) Composition for Cleaning Soot and Carbon Deposits

(71) Applicant: Barbara Wood, Columbia, MD (US)

(72) Inventor: Barbara Wood, Columbia, MD (US)

(21) Appl. No.: 13/304,661

(22) Filed: Nov. 27, 2011

(51) Int. Cl. C11D 3/60

(52) U.S. Cl. 510/109

(57) ABSTRACT

A soot cleaning composition and method comprising an aqueous solution of about 0.1 to 11 weight percent of a mixture of quaternary ammonium compounds; about 0.1 to about 15 weight percent of nonionic or anionic surfactant component; and about 0.1 to about 10 weight percent of cleaners and chelants, and where appropriate about 2 to 60% w/w hydrocarbon propellant; said weight percentages based on the total weight of the composition.

### CROSS-REFERENCE TO RELATED APPLICATIONS

### Field of the Invention

This invention relates generally to chemical composition for cleaning soot and carbon deposits on hard surfaces.

### BACKGROUND OF THE INVENTION

Soot, as an airborne contaminant in the environment has many different sources but they are all the result of some form of pyrolysis. They include soot from internal combustion engines, power plant boilers, hog-fuel boilers, ship boilers, central steam heat boilers, waste incineration, local field burning, house fires, forest fires, fireplaces, furnaces, etc. These exterior sources also contribute to the indoor environment sources such as smoking of plant matter, cooking, oil lamps, candles, quartz/halogen bulbs with settled dust, fireplaces, defective furnaces, etc. Soot in very low concentrations is capable of darkening surfaces or making particle agglomerates, such as those from ventilation systems, appear black. Soot is the primary cause of “ghosting”, the discoloration of walls and ceilings or walls and flooring where they meet. It is generally responsible for the discoloration of the walls above baseboard electric heating units.

As used herein, soot is a general term that refers to impure carbon particles resulting from the incomplete combustion of hydrocarbons and includes the product of gas-phase combustion process as well as residual pyrolyzed fuel particles such as cenospheres, charred wood, petroleum coke, and so on, that may become airborne during pyrolysis and that are more properly identified as cokes or chars. Gas-phase soots contain polycyclic aromatic hydrocarbons which are known mutagens.

The formation of soot depends strongly on the fuel composition. The rank ordering of sooting tendency of fuel components is: naphthalenes→benzenes→aliphatics. However, the order of sooting tendencies of the aliphatics (alkanes, alkenes, alkynes) varies dramatically depending on the flame type. The difference between the sooting tendencies of aliphatics and aromatics is thought to result mainly from the different routes of formation. Aliphatics appear to first form acetylene and polyacetylenes; aromatics can form soot both by this route and also by a more direct pathway involving ring condensation or polymerization reactions building on the existing aromatic structure.

The production of soot in a flame is a complex process consisting of several chemical reactions taking place in series. In the fuel-pyrolysis zone of the flame, typically clear or blue, the fuel molecules are broken down into various fragments, including carbon-ring structures, acetylene (C2H2), the radical C3H3 (and higher order), as well as monatomic and diatomic hydrogen. As the combustion process continues, the radicals quickly combine into new structures, giving off heat. These precursors polymerize into larger “pre-soot” chains then gather into formations of hydrogen-rich spheres in the soot-inception zone. In the soot-growth zone these spheres give up their hydrogen gas through diffusion, resulting in solids consisting of several of the formerly liquid spheres stuck together into larger chains. It is this portion of the flame that has the bright yellow color. Hydrogen-rich examples then further oxidize, releasing more heat. In perfect combustion the soot would break down into almost pure CO2 and H2O; it is only in incomplete combustion that the soot is able to form and escape the flame.

Soot is in the general category of airborne particulate matter, and as such is considered hazardous to the lungs and general health when the particles are less than five micrometres in diameter, as such particles are not filtered out by the upper respiratory tract. Smoke from diesel engines, while composed mostly of carbon soot, is considered especially dangerous—owing both to its particulate size and to the many other chemical compounds present. Long-term exposure to urban air pollution containing soot increases the risk of coronary heart disease.

Diesel exhaust gas is a major contributor to combustion derived particulate matter air pollution. Soot particles emitted from a diesel engine are usually observed as chain aggregates composed of several tens to hundreds of primary spherical particles and contain many polyaromatic hydrocarbons which represent a hazard to human health.

Soot cleaning can be a messy chore. Unfortunately, routine cleaning of soot-covered surfaces is necessary for proper sanitation and in some cases, to the proper function of the equipment in question. Harsh chemical cleansers, wire brush or acid solutions have all been employed to clean soot in methods that require too much effort or are too dangerous. In one method, a creamy mixture of soap and table salt is rubbed on the surface, allowed to dry and removed with a stiff brush. In another method, a thick mixture of soap or detergent, pumice, ammonia and hot water is painted on the surface to be cleaned, allowed to dry and rubbed off with a wet scrub brush. In yet another method, naphtha soap is mixed with water and boiled to smelting, cooled, ammonia and pumice is added and mixed with the smelted naptha soap. The mixture is brushed unto the sooty surface, and rubbed off with a stiff bristle brush. Then the surface is rinsed with warm water and detergents.

All these methods involve using a stiff brush to scrub away the soot. There is need for a composition that will break apart and remove soot and build up with little effort without harsh chemicals and scrubbing and is safe to use most surfaces. In the instant method, vacuum or broom may be use to remove loose particles so that the chemical composition of the present invention may now be used to remove the soot stain without creating a bigger mess by wetting ashes or other loose chunks of dirt.

### SUMMARY OF THE INVENTION

A soot cleaning composition has been discovered comprising an aqueous solution of about 0.1 to 11 weight percent of a mixture of quaternary ammonium compounds; about 0.1 to about 15 weight percent of nonionic or anionic surfactant component; and about 0.1 to about 10 weight percent of cleaners and chelants, and where appropriate about 2 to 60% w/w hydrocarbon propellant; said weight percentages based on the total weight of the composition.

As used herein, chelants and cleaners comprise surfactant additives, builders, chelating and sequestering agents, dyes, fragrances, buffers, acids, preservatives, anti-resoiling agents, corrosion inhibitors, co-surfactants, abrasives, supplementary propellants, enzymes, and mixtures thereof.

A novel method for cleaning particles of soot from hard surfaces comprising the steps of contacting a cleaning composition comprising about 0.1 to 11 weight percent of a mixture of quaternary ammonium compounds; about 0.1 to about 15 weight percent of nonionic or anionic surfactant component; and about 0.1 to about 10 weight percent of cleaners and chelants, and where appropriate about 2 to 60% w/w hydrocarbon propellant; said weight percentages based on the total weight of the composition with a soot covered surface thereby removing soot particles.

Surprisingly, the combination of a specific composition of quaternary ammonium compounds, the nonionic or anionic surfactant components, and the cleaners and chelants employed within the stated amounts has been found to provide a synergistic effect on cleaning soot covered surfaces. This cleaning composition not only uses a comparatively low level of quaternary ammonium compounds, it also provides an acceptable cleaning efficacy; an acceptable level irritation or toxicity profile; and the broad spectrum antimicrobial activity of the quaternary ammonium compounds.

### BRIEF DESCRIPTION OF PREFERRED EMBODIMENTS OF THE INVENTION

Not Applicable

### DETAILED DESCRIPTION OF PREFERRED EMBODIMENTS OF THE PRESENT INVENTION

In the following description and claims, all the percentages are weight percentages based on the total weight of the composition, unless otherwise defined.

Generally any of the broad class of quaternary ammonium compounds may be used as the quaternary ammonium compound component in this composition. Preferably more than one quaternary ammonium compound is employed. Useful quaternary ammonium compounds include, for example, those quaternary ammonium compounds represented by the following structural formula below:

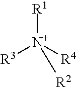

wherein R1, R2, R3, and R4 may be described in three general groups, as provided below.

In a group of preferred quaternary ammonium compounds, R1 and R2 are C1-C7 alkyl groups (preferably methyl groups); R3 is a benzyl group or a benzyl group substituted with an alkyl group having about 1 to 7 carbon atoms, R4 is an alkyl group having about 10 to 20, and preferably 12 to 18 carbon atoms; and wherein the quaternary ammonium compound is a chloride or a bromide.

More preferably, the quaternary ammonium compound component is a combination of two or more of the following: n-Alkyl (C14) dimethly benzyl ammonium chloride, n-Alkyl (C16) dimethly benzyl ammonium chloride, n-Alkyl (C12) dimethly benzyl ammonium chloride, n-Alkyl (C18) dimethly benzyl ammonium chloride, n-Alkyl (C12) dimethly ethylbenzyl ammonium chloride, n-Alkyl (C14) dimethly ethylbenzyl ammonium chloride, n-Alkyl (C16) dimethly ethylbenzyl ammonium chloride, n-Alkyl (C18) dimethly benzyl ammonium chloride; or bromides thereof.

Most preferably employed as the quaternary ammonium compounds of the present invention comprises about 0.1-10 wt % n-alkyl (60% C14, 30% C16, 5% C12, 5% C18) dimethly benzyl ammonium chloride and about 0.1-10 wt % n-alkyl (68% C12, 32% C14) dimethly ethylbenzyl ammonium chloride, or bromides thereof. Quaternary ammonium compounds are well known and available commercially from a number of suppliers.

Preferably the quaternary ammonium compound component is employed in such amounts that the composition is provided with sufficient cleaning efficacy without exhibiting an undue irritation to eyes or skin. Higher amounts of quaternary compound(s) than those amounts taught herein may be used probably at the risk of irritation to eyes and skin.

One or more surfactants are included in a total amount of from 0.1 to 15% w/w, preferably from 1 to 10% w/w, most preferably from 5 to 10% w/w. Nonionic and/or anionic surfactants are preferred. Desirably, the surfactants also contribute to soot cleaning.

When more than one surfactant is used, an individual surfactant component may be in a concentration as low as 0.1 to 5.0% w/w. For example, sodium lauroyl sarcosinate may be used in a concentration of 0.2% w/w. In a further example, Surfadone LP300 in a concentration of 0.5% w/w may be used to improve wetting and stain removal.

Examples of surfactants that may be used are as follows:

Nonionic surfactants—sorbitan fatty acid ester ethoxylates, glycerol fatty acid ester ethoxylates, sorbitan fatty acid esters, glycerol fatty acid esters, coconut monoethanolamide ethoxylates, tall oil ethoxylates, polypropylene glycol ethoxylates, fatty acid alkanolamides such as coconut mono- and diethanolamide, fatty alcohol ethoxylates and propoxylates, amine oxides, n-alkyl pyrrolidones, alkyl polysaccharides such as sucrose esters and alkyl polyglycosides, alkyl phenol ethoxylates, ethoxylated castor oil, fatty acid ethoxylates, fatty amine ethoxylates, polyglycerol fatty acid esters.

Anionic surfactants—sodium lauryl ether sulfate, triethanolamine lauryl sulphate, magnesium lauryl sulfate, sulfosuccinate esters, ammonium lauryl sulfate, alkyl sulfonates, sodium lauryl sulfate, sodium alpha olefin sulfonates, alkyl sulfates, sulfated alcohol ethoxylates, sulfated alkyl phenol ethoxylates, sodium xylene sulfonate, alkylbenzene sulphonates such as triethanolamine dodecylbenzene sulfonate, sodium dodecylbenzene sulfonate, calcium dodecylbenzene sulfonate, xylene sulfonic acid, dodecylbenzene sulfonic acid, N-alkoyl sarcosinates such as sodium lauroyl sarcosinate, dialkylsulfosuccinates, N-alkoyl sarcosines such as lauroyl sarcosine, alkyl ether carboxylates, soaps including sodium, potassium, magnesium, calcium, alkanolamine and amine soaps.

Preferred nonionic surfactants that may be employed in the composition are generally water soluble and include one or more of the following: amine oxides, block polymers, alkoxylated alkanolamides, ethoxylated alcohols, and ethoxylated alkyl phenols, and the like, with a more complete listing of commercially available nonionic surfactants found under these class listings the “Chemical Classification” Section of McCutcheon's Emulsifier & Detergents North American Edition, 2011.

More preferred nonionic surfactants may be listed under three general groups of compounds: (1) amine oxide compounds; (2) ethoxylated phenols and ethoxylated alcohols formed by condensation of either an alkyl phenol or an aliphatic alcohol with sufficient ethylene oxide to produce a compound having a polyoxyethylene, i.e., a chain composed of recurring (—OCH₂CH₂—) groups; and (3) alkoxylated alkanolamides, each of which are described more particularly hereinafter.

The first group of nonionic surfactants preferred, amine oxides, may be defined as one or more of the following of the four general classes:

(1) Alkyl di(lower alkyl) amine oxides in which the alkyl group has about 10-20, and preferably 12-16 carbon atoms, and can be straight or branched chain, saturated or unsaturated. The lower alkyl groups include between 1 and 7 carbon atoms. Examples include lauryl dimethyl amine oxide, myristyl dimethyl amine oxide, and those in which the alkyl group is a mixture of different chain lengths, such as lauryl myristyl dimethyl amine oxide, dimethyl cocoamine oxide, dimethyl (hydrogenated tallow) amine oxide, and myristyl/palmityl dimethyl amine oxide;
(2) Alkyl di(hydroxy lower alkyl) amine oxides in which the alkyl group has about 10-20, and preferably 12-16 carbon atoms, and can be straight or branched chain, saturated or unsaturated. Examples are bis(2-hydroxyethyl) cocoamine oxide, bis(2-hydroxyethyl tallowamine oxide; and bis(2-hydroxyethyl) stearylamine oxide);
(3) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
(4) Alkylmorpholine oxides in which the alkyl group has about 10-20, and preferably 12-16 carbon atoms, and can be straight or branched chain, saturated or unsaturated.

The second group of preferred nonionic surfactants, ethoxylated alcohols and ethoxylated phenols, are well known and may be formed by condensation of an alkyl phenol, an aliphatic alcohol, or mixtures thereof, with sufficient ethylene oxide to produce a compound having a polyoxyethylene. Preferably the number of ethylene oxide units are present in an amount sufficient to insure solubility of the compound in the aqueous composition of this invention or in any dilution thereof. More preferably the ethoxylated alcohols and phenols are produced by condensation of about 4-16 (more preferably 8-13), moles of ethylene oxide with 1 mole of the parent compound (i.e. alkyl phenol or aliphatic alcohol). As known to those skilled in the art, the number of moles of ethylene oxide which are condensed with one mole of parent compound depends upon the molecular weight of the hydrophobic portion of the condensation product. The parent compounds that may be combined with the ethylene oxide may include one or more of the following:

(1) an alkyl phenol having about 1-15, and preferably 7-10, carbon atoms (saturated or unsaturated) in the alkyl group [including phenol, methyl phenol (cresol), ethyl phenol, hexyl phenol, octyl phenol, dicylphenol, nonylphenol, dodecylphenol, and the like]; and
(2) a primary, tertiary, or secondary aliphatic alcohol having about 10-20, and preferably 11-15, carbon atoms, (including decyl alcohol, dodecyl alcohol, tridecyl alcohol, hexadecyl alcohol, octadecyl alcohol, and the like).

The third group of preferred nonionic surfactants, alkoxylated alkanolamides, are C₈-C₂₄ alkyl di(C₂-C₃ alkanol amides), as represented by the following formula:

R₅—CO—NH—R₆—OH

wherein R₅ is a branched or straight chain C₈-C₂₄ alkyl radical, preferably a C₁₀-C₁₆ alkyl radical and more preferably a C₁₂-C₁₄ alkyl radical, and R₆ is a C₁-C₄ alkyl radical, preferably an ethyl radical.

The nonionic surfactant is preferably employed in an amount ranging from about 0.1 to weight percent, more preferably from 5 to 10 weight percent based on the total weight of the composition.

More preferably, the nonionic surfactant component suitable for this invention is a combination of an ethoxylated alcohol compound, an alkoxylated alkanolamide compound, and an alkyl di(lower alkyl) amine oxides in which the alkyl group has 10-20 carbon atoms. Most preferably, the nonionic surfactant component is a combination of a secondary alcohol ethoxylate, an ethoxylated alkanolamide, and an alkyl di(lower alkyl) amine oxide in which the alkyl group has 12-16 carbon atoms.

The ratio of each of the preferred three nonionic surfactant compounds used as the surfactant component may vary widely. Preferably, when this preferred combination of nonionic surfactants is employed, the ratio is as follows: ethoxylated alcohol ranging from about 1 to about 95 parts: alkoxylated alkanolamide ranging from about 98.99 to about 1 parts: amide oxide ranging from about 0.01 to about 4.5 parts amine oxide, based on 100 parts nonionic surfactant. More preferably, the ratio of preferred surfactants is: ethoxylated alcohol ranging from 70 to 90 parts: alkoxylated alkanolamide ranging from 29 to 10 parts: amide oxide ranging from 1 to 4 parts. Most preferably the ratio of preferred surfactants is: ethoxylated alcohol ranging from 78 to 82 parts: alkoxylated alkanolamide ranging from 19 to 15 parts: amide oxide ranging from 3 to 4 parts.

Nonionic surfactant compounds are widely available commercially.

In addition to the quaternary ammonium compound component, nonionic surfactant component, the composition may also be formulated to include other optional ingredients, as well known to those skilled in the art. For example optional ingredients that may employed include, but are not limited to surfactant additives, builders, chelating and sequestering agents, dyes, fragrances, buffers, acids, preservatives, anti-resoiling agents, corrosion inhibitors, co-surfactants, abrasives, supplementary propellants, enzymes, and so on.

Surfactant additives may be included to enhance cleaning and washout performance. Examples include good wetting agents, dispersing agents and the like. Specific examples include Surfadone LP 300 (n-dodecyl-2-pyrrolidone available from ISP) and Surfadone LP 100 (n-octyl-2-pyrrolidone); as good wetting agents, sodium lauryl ether sulphate as a dispersing agent for inorganic matter.

Examples of builders that may be used in the formulation include, but are not limited to, water soluble sodium, potassium or ammonium salt of carbonate, bicarbonate, polyphosphate, polycarboxylate or aminopolycarboxylate, including, for example, sodium carbonate, sodium bicarbonate, potassium tripolyphosphate, potassium pyrophosphate, sodium citrate dihydrate, trisodium phosphate, trisodium nitrilotriacetate, tetrasodium ethylenediamine tetraacetate, and mixtures thereof, and so on, all widely commercially available. A particularly preferred builder component is a combination of sodium citrate and triethanolamine. Phosphate free compositions are preferred.

Chelating agents (also commonly referred to as sequestering agents) that may be used in the composition are well known to those skilled in the art and include, but are not limited to, sodium gluconate, gluconic acid, citric acid, sorbitol, tartaric acid, anthranilic acid, polyacrylic acid, sodium hexameta phosphate, mixed alkyl-diaminepolyacetic acid (as sodium salts and alkanolamines), tetrasodium ethylenediamine tetraacetate, and so on, as listed, for example in McCutcheon's Emulsifiers & Detergents North American Edition. Particularly preferred as a chelating agent is tetrasodium ethylenediamine tetraacetate.

Anti-resoiling agents such as Zonyl 7950, Zelan 338 (available from Dupont), Repel-o-Tex QCJ and QCX (available from Rhone-Poulenc) may be used.

Co-surfactants (water immiscible coupling agents)—including C₅-C₁₆ alcohols.

Thickening agents may be used particularly to retard release of propellant from the bubbling surface. Thickening agents may also be used for particular compositional requirements to retain composition on angular surfaces.

Abrasives may be used for hard surface cleaning compositions. An abrasive may be deposited from the composition and mechanically agitated to provide additional cleaning. Compounds such as fumed silica may be used.

Antimicrobials including disinfectant, antibacterial and germicidal compounds, may also be used.

Enzymes such as protease, amylase, lipase and cellulose may be optional ingredients.

Solvents for specific co-soiling matter other than soot, such as ethanol, iso-propanol, glycol ethers, N-methylpyrrolidone, white spirit, kerosene, n-paraffins, iso-paraffins, naphthene-containing solvents, ester solvents, terpenes, cycloalkanes, hydrofluorocarbon solvents may also be used.

One or more hydrocarbon propellants are used in the compositions of the invention in a total amount from 2 to 60% w/w. Amongst the hydrocarbon propellants that may be used are acetylene, methane, ethane, ethylene, propane, propene, n-butane, n-butene, iso-butane, iso-butene, pentane, pentene, iso-pentane and iso-pentene. Mixtures of these propellants may also be used.

Indeed, it should be noted that commercially available propellants typically contain a number of hydrocarbon gases. For example, unodourized commercial butane (available from Boral Gas) contains predominantly n-butane and some iso-butane along with small amounts of propane, propene, pentane and butene.

Preferred propellants include propane, n-butane, iso-butane, pentane and iso-pentane, whilst most preferred are propane, n-butane and iso-butane.

Broadly, the concentration of propellant will be from 2 to 60% w/w, generally the concentration will be from 5 to 50% w/w; preferably from 2 to 10% w/w.

Particularly preferred are mixtures of propane, n-butane and iso-butane.

The person skilled in the art will appreciate that the pressure in an aerosol package will be determined by the propellant or mixture of propellants. This pressure will have a determining effect on spray rate. Hence for any particular valve system, varying the propellant or propellant mixture will allow for the selection of a desired spray rate.

Likewise, for a particular propellant or propellant mixture, it is possible to select a valve and actuator system to achieve a desired rate. Supplementary propellants such as dimethyl ether and hydrofluorocarbons may be used.

It is preferred that sufficient of the propellant be retained in the composition on discharge so to create a bubbling action. The bubbling action is an important characteristic of the composition of the invention and would tend to lift the soot particles away from the surface to be cleaned.

In addition to the active and optional ingredients, the inventive composition contains water. As set forth above, the amounts of the ingredients are provided such that a substantial portion of the balance of the composition is water. Although the composition may be prepared as a concentrate which is typically diluted prior to usage, the composition is preferably used in an aerosol form incorporating a hydrocarbon propellant. By filing the composition into aerosol packages and gassing with propellant in a conventional manner.

As known to those skilled in the art, cleaning efficacy may include success in reducing soot soiled surfaces, and preferably also providing a deodorizing effect. Any number of tests may provide measurement of cleaning efficacy, such as tests devised by ASTM (American Standard Test Methods), Chemical Specialties Manufacturers Association (CSMA), and Shell Oil Company.

An evaluation of the level of irritation to eyes when accidentally exposed to the composition by spillage or splashing or to skin caused by exposure to the composition may be measured by any number of techniques, such as, the well known Draize Test and Repeated Insult Patch Test (RIPT). An acceptable level of irritation may take into account the usage and concentration levels of the composition, with higher concentrations naturally having a tendency to increase irritation to eyes or skin. As normally used, preferably the cleaning composition provides an acceptable irritation.

In addition to providing advantages already described, the cleaning composition is formulated such that it is of a moderate foaming propensity. Also, preferably the composition is employed in such a dilution such that a minimal residue is left on the cleaned hard surface once the surface dries.

The compositions of the invention may be prepared by entirely conventional procedures with no particular technique being required.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed:

1. A soot cleaning composition has been discovered comprising an aqueous solution of about 0.1 to 11 weight percent of a mixture of quaternary ammonium compounds; about 0.1 to about 15 weight percent of nonionic or anionic surfactant component; and about 0.1 to about 10 weight percent of cleaners and chelants, and where appropriate about 2 to 60% w/w hydrocarbon propellant; said weight percentages based on the total weight of the composition.

2. The composition of claim 1, wherein the quarternary ammonium compound is at least one selected from the group comprising n-Alkyl (C14) dimethly benzyl ammonium chloride, n-Alkyl (C16) dimethly benzyl ammonium chloride, n-Alkyl (C12) dimethly benzyl ammonium chloride, n-Alkyl (C18) dimethly benzyl ammonium chloride, n-Alkyl (C12) dimethly ethylbenzyl ammonium chloride, n-Alkyl (C14) dimethly ethylbenzyl ammonium chloride, n-Alkyl (C16) dimethly ethylbenzyl ammonium chloride, and n-Alkyl (C18) dimethly benzyl ammonium chloride; or bromides thereof.

3. The composition of claim 2, wherein the quaternary ammonium compounds of the present invention comprises about 0.1-10 wt % n-alkyl (60% C14, 30% C16, 5% C12, 5% C18) dimethly benzyl ammonium chloride and about 0.1-10 wt % n-alkyl (68% C12, 32% C14) dimethly ethylbenzyl ammonium chloride; or bromides thereof.

4. The composition of claim 2 or 3, further comprising about 0.1 to about 15% w/w of at least one surfactant selected from the group comprising sorbitan fatty acid ester ethoxylates, glycerol fatty acid ester ethoxylates, sorbitan fatty acid esters, glycerol fatty acid esters, coconut monoethanolamide ethoxylates, tall oil ethoxylates, polypropylene glycol ethoxylates, fatty acid alkanolamides such as coconut mono- and diethanolamide, fatty alcohol ethoxylates and propoxylates, amine oxides, n-alkyl pyrrolidones, alkyl polysaccharides such as sucrose esters and alkyl polyglycosides, alkyl phenol ethoxylates, ethoxylated castor oil, fatty acid ethoxylates, fatty amine ethoxylates, and polyglycerol fatty acid esters.

5. The composition of claim 2 or 3, further comprising about 0.1 to about 15% w/w of at least one surfactant selected from the group comprising sodium lauryl ether sulfate, triethanolamine lauryl sulphate, magnesium lauryl sulfate, sulfosuccinate esters, ammonium lauryl sulfate, alkyl sulfonates, sodium lauryl sulfate, sodium alpha olefin sulfonates, alkyl sulfates, sulfated alcohol ethoxylates, sulfated alkyl phenol ethoxylates, sodium xylene sulfonate, alkylbenzene sulphonates such as triethanolamine dodecylbenzene sulfonate, sodium dodecylbenzene sulfonate, calcium dodecylbenzene sulfonate, xylene sulfonic acid, dodecylbenzene sulfonic acid, N-alkoyl sarcosinates such as sodium lauroyl sarcosinate, dialkylsulfosuccinates, N-alkoyl sarcosines such as lauroyl sarcosine, alkyl ether carboxylates, soaps including sodium, potassium, magnesium, calcium, alkanolamine and amine soaps.

6. The composition of claim 3 wherein chelants and cleaners comprise surfactant additives, builders, chelating and sequestering agents, dyes, fragrances, buffers, acids, preservatives, anti-resoiling agents, corrosion inhibitors, co-surfactants, abrasives, supplementary propellants, enzymes, and mixtures thereof.

7. The composition of claim 6, wherein surfactant additives is at least one selected from the group consisting of n-dodecyl-2-pyrrolidone, n-octyl-2-pyroolidone, and sodium lauryl ether sulphate.

8. The composition of claim 6, wherein builders is at least one selected from the group consisting of sodium carbonate, sodium bicarbonate, potassium tripolyphosphate, potassium pyrophosphate, sodium citrate dihydrate, trisodium phosphate, trisodium nitrilotriacetate, and tetrasodium ethylenediamine tetraacetate.

9. The composition of claim 6, wherein chelating agents is at least one selected from the group consisting of sodium gluconate, gluconic acid, citric acid, sorbitol, tartaric acid, anthranilic acid, polyacrylic acid, sodium hexameta phosphate, mixed alkyl-diaminepolyacetic acid (as sodium salts and alkanolamines), and tetrasodium ethylenediamine tetraacetate

10. The composition of claim 6, wherein anti-resoiling agents is at least one selected from the group consisting of Zonyl 7950, Zelan 338, Repel-o-Tex QCJ and QCX.

11. The composition of claim 6, wherein the co surfactants comprise C₅-C₁₆ alcohols.

12. The composition of claim 6, further comprising solvents for specific co-soiling matter other than soot comprising at least one selected from the group consisting of ethanol, iso-propanol, glycol ethers, N-methylpyrrolidone, white spirit, kerosene, n-paraffins, iso-paraffins, naphthene-containing solvents, ester solvents, terpenes, cycloalkanes, and hydrofluorocarbon solvents.

13. The composition of claim 3, wherein the hydrocarbon propellant is at least one selected from the group consisting of acetylene, methane, ethane, ethylene, propane, propene, n-butane, n-butene, iso-butane, iso-butene, pentane, pentene, iso-pentane and iso-pentene.

14. A method for cleaning particles of soot from hard surfaces comprising the steps of contacting a cleaning composition comprising about 0.1 to 11 weight percent of a mixture of quaternary ammonium compounds; about 0.1 to about 15 weight percent of nonionic or anionic surfactant component; and about 0.1 to about 10 weight percent of cleaners and chelants, and where appropriate about 2 to 60% w/w hydrocarbon propellant; said weight percentages based on the total weight of the composition with a soot covered surface thereby removing soot particles.
